(19) United States
(12) Patent Application Publication
(10) Pub. No.: US 2026/0052051 A1
(43) Pub. Date: Feb. 19, 2026

(54) SYSTEMS, APPARATUSES, METHODS, AND NON-TRANSITORY COMPUTER-READABLE STORAGE DEVICES FOR WIRELESS COMMUNICATION EMPLOYING 2X-LONG TRAINING FIELDS FOR DISTRIBUTIVE RESOURCE UNIT TRANSMISSION

(71) Applicant: HUAWEI TECHNOLOGIES CO., LTD., Shenzhen (CN)

(72) Inventors: Jung Hoon Suh, Kanata (CA); Yan Xin, Kanata (CA); Mahmoud Hasabelnaby, Kelowna (CA); Sara Norouzi, Vancouver (CA); Osama Aboul-Magd, Kanata (CA)

(21) Appl. No.: 18/923,235

(22) Filed: Oct. 22, 2024

Related U.S. Application Data
(60) Provisional application No. 63/684,117, filed on Aug. 16, 2024.

(51) Int. Cl. H04L 27/26; H04L 5/00

(52) U.S. Cl. CPC H04L 27/2613; H04L 5/0046

(57) ABSTRACT

A communication method has the step of: generating time-domain samples of an orthogonal frequency-division multiplexing (OFDM) symbol, the time-domain samples comprising a plurality of sets of samples, each of the plurality of sets of samples being same as another one of the plurality of sets of samples or being obtainable based on the another one of the plurality of sets of samples by using one or more operations including negating, complex conjugate, or a combination thereof; and transmitting a packet comprising a portion of the time-domain samples of the OFDM symbol, the portion of the time-domain samples comprising one or more selected sets of samples selected from the plurality of sets of samples in accordance with a ratio.

### CROSS-REFERENCE TO RELATED APPLICATIONS

This application claims the benefit of U.S. Provisional Patent Application Ser. No. 63/684,117, filed Aug. 16, 2024, the content of which is incorporated herein by reference in its entirety.

### FIELD OF THE DISCLOSURE

The present disclosure relates generally to communication systems, apparatuses, methods, and non-transitory computer-readable storage devices, and in particular to systems, apparatuses, methods, and non-transitory computer-readable storage devices for wireless communication employing 2×-long training fields (LTFs) for distributive resource unit (DRU) transmission.

### BACKGROUND

Wireless communication systems such as IEEE 802.11 series (that is, WI-FI® series; WI-FI is a registered trademark of Wi-Fi Alliance, Austin, TX, USA) are known. In recent IEEE 802.11 series, the distributive resource unit (DRU) transmission has been introduced in the ultra-high reliability (UHR) system for a trigger-based (TB) physical layer protocol data unit (PPDU). The long training field (LTF) has been only occupied to the subcarriers overlapped with the scheduled resource unit (RU), and the same principle may continue to be applied to the DRU as well.

However, in prior art, the DRU tone plans do not include any LTF arrangement, and there is no LTF arrangement in the application of DRU in a TB PPDU transmission. Moreover, the 2×-LTF sequence may not be assigned to the tones where the DRU is scheduled. Consequently, it may not be possible to apply the 2×-LTF sequence as it is defined in the highly efficient (HE) or extremely high throughput (EHT) systems.

Accordingly, there is a desire for a solution to this issue.

### SUMMARY

According to one aspect of this disclosure, there is provided a first communication method comprising: generating a long training field (LTF) in time domain having a plurality of repeated set of samples; removing, such as truncating, a subset of the plurality of repeated set of samples in accordance with a ratio indicating a number of the portion of the time-domain samples over a total number of the time-domain samples of the OFDM symbol, to obtain a reduced-length LTF; and transmitting a packet comprising the reduced-length LTF corresponding to a set of distributive resource units (DRU) tones.

According to one aspect of this disclosure, there is provided a second communication method comprising: transmitting a packet comprising the first half samples of 4×-LTF corresponding to the DRU which has the repetition pattern in the time-domain samples.

In some embodiments, the transmission may be the 2×-LTF transmission.

In some embodiments, there is no need to define a separate 2×-LTF sequence, and rather, to transmit a half of time-domain samples, when the 4×-LTF sequence is applied to the DRU and generates the repeated time-domain samples.

In some embodiments, the 4×-LTF sequence is applied only to subcarriers corresponding to the non-zero DRU tones, even when transmitting the 2×-LTF based frame is needed, which gives rise to LTF overhead reduction.

In some embodiments, for the 2×-LTF symbol transmission, those repeated samples in the time domain after the Inverse Discrete Fourier Transform (IDFT) of the LTF symbol are cut in half (for example, truncating half of the repeated samples of the 4×-LTF sequence in the time domain) and transmit, which may reduce the LTF symbol size to one half. Accordingly, 2×-LTF transmission is made possible for the DRU-based TB PPDU.

In some embodiments, the 4×-LTF sequences are occupied at the same tones as the data DRU tones with the rest unoccupied in order to apply the 2×-LTF transmission, allowing application of the LTF sequences for the 2×-LTF-based TB PPDU transmission.

According to one aspect of this disclosure, there is provided one or more circuits such as one or more processors for performing any of the above-described methods.

According to one aspect of this disclosure, there is provided one or more processors functionally connected to one or more memories for performing any of the above-described methods.

According to one aspect of this disclosure, there is provided a third communication method comprising: generating time-domain samples of an orthogonal frequency-division multiplexing (OFDM) symbol, the time-domain samples comprising a plurality of sets of samples, each of the plurality of sets of samples being the same as another one of the plurality of sets of samples or being obtainable based on the another one of the plurality of sets of samples by using one or more operations including negating, complex conjugate, or a combination thereof; and transmitting a packet comprising a portion of the time-domain samples of the OFDM symbol, the portion of the time-domain samples comprising one or more selected sets of samples selected from the plurality of sets of samples in accordance with a ratio indicating a number of the portion of the time-domain samples over a total number of the time-domain samples of the OFDM symbol.

In some embodiments, the third communication method further comprises: transmitting a trigger frame indicating the ratio in a common field or a user info field of the trigger frame.

In some embodiments, the portion of the time-domain samples of the OFDM symbol comprises first half of the time-domain samples of the OFDM symbol.

In some embodiments, the time-domain samples of the OFDM symbol comprise four sets of samples, and the portion of the time-domain samples of the OFDM symbol comprises one of the four sets of samples.

In some embodiments, the OFDM symbol comprises a first long training field (LTF) sequence applied to a set of distributive resource units (DRU) tones, and the portion of the time-domain samples of the OFDM symbol correspond to a second LTF sequence.

In some embodiments, the first LTF sequence is a 4×-LTF sequence, and the second LTF sequence is a 2×-LTF sequence.

According to one aspect of this disclosure, there is provided a fourth communication method comprising: receiving a packet comprising a portion of time-domain samples of an orthogonal frequency-division multiplexing (OFDM) symbol; and obtaining all time-domain samples of the OFDM symbol based on the portion of time-domain samples for channel estimation or data reception.

In some embodiments, said obtaining all time-domain samples of the OFDM symbol comprises: in accordance with a ratio indicating a number of the portion of the time-domain samples over a total number of the time-domain samples of the OFDM symbol, obtaining one or more sets of time-domain samples based on the portion of time-domain samples, each of the one or more sets of time-domain samples being the same as the portion of time-domain samples or being obtained based on the portion of time-domain samples by using one or more operations including negating, complex conjugate, or a combination thereof; and combining the portion of time-domain samples and the one or more sets of time-domain samples to obtain all time-domain samples of the OFDM symbol.

In some embodiments, the fourth communication method further comprises: receiving a trigger frame; and obtaining the ratio from a common field or a user info field of the trigger frame.

In some embodiments, said obtaining the one or more sets of time-domain samples comprises: obtaining one set of time-domain samples; and said combining the portion of time-domain samples and the one or more sets of time-domain samples comprises: appending the one set of time-domain samples to an end of the portion of time-domain samples.

In some embodiments, said obtaining the one or more sets of time-domain samples comprises: obtaining three sets of time-domain samples.

In some embodiments, the OFDM symbol comprises a first long training field (LTF) sequence applied to a set of distributive resource units (DRU) tones, and the portion of the time-domain samples of the OFDM symbol correspond to a second LTF sequence.

In some embodiments, the first LTF sequence is a 4×-LTF sequence, and the second LTF sequence is a 2×-LTF sequence.

According to one aspect of this disclosure, there is provided one or more processors functionally coupled to one or more non-transitory computer-readable storage media, wherein the one or more non-transitory computer-readable storage media comprise computer-executable instructions; and wherein the instructions, when executed, cause the one or more processors to perform any of the above-described methods.

According to one aspect of this disclosure, there is provided one or more non-transitory computer-readable storage media comprising computer-executable instructions, wherein the instructions, when executed, cause one or more processors to perform any of the above-described methods.

According to one aspect of this disclosure, there is provided an apparatus comprising: one or more processors functionally connected to one or more memories for performing any of the above-described methods.

According to one aspect of this disclosure, there is provided one or more non-transitory computer-readable storage devices comprising computer-executable instructions, wherein the instructions, when executed, cause one or more circuits to perform any of the above-described methods.

According to one aspect of this disclosure, there is provided an apparatus, and configured to perform the any of above-described methods and their embodiments. Specifically, the apparatus includes one or more units configured to perform the any of above-described methods and their embodiments.

According to one aspect of this disclosure, there is provided a computer-readable storage medium. The computer-readable storage medium stores a computer program, and when the computer program is executed by an apparatus, the apparatus is enabled to implement the any of above mentioned methods and their embodiments.

According to one aspect of this disclosure, there is provided a computer program product including one or more instructions. When the instructions are executed by an apparatus such as a computer, the apparatus is enabled to implement the any of above mentioned methods and their embodiments.

According to one aspect of this disclosure, there is provided a computer program. When the computer program is executed by a computer, an apparatus is enabled to implement the any of above-described methods and their embodiments.

According to one aspect of this disclosure, there is provided a communication system. The communication system includes a first communication-node and/or a second communication-node, the first communication-node is configured to perform any of the above-described methods regarding with the first communication-node as stated above, and the second communication-node is configured to perform any of the above-described methods regarding with the second communication-node as stated above.

According to one aspect of this disclosure, there is provided an apparatus for implementing any of the above-described methods in any possible implementation of the foregoing aspects.

### BRIEF DESCRIPTION OF THE DRAWINGS

FIG. 1 is a simplified schematic diagram showing a communication system, according to some embodiments of this disclosure;

FIG. 2 is a simplified schematic diagram of an access point (AP) of the communication network of the communication system shown in FIG. 1;

FIG. 3 is a simplified schematic diagram of a station (STA) of the communication system shown in FIG. 1;

FIG. 4 is a schematic diagram showing a tone plan example for 20 MHz;

FIG. 5 is a schematic diagram showing a tone plan example for 40 MHz; and

FIG. 6 is a schematic diagram showing a tone plan example for 80 MHz.

### DETAILED DESCRIPTION

Embodiments disclosed herein relate to systems, apparatuses, methods, and non-transitory computer-readable storage devices for wireless communication. The wireless communication systems, apparatuses, and methods disclosed herein may be any suitable systems, apparatuses, and methods for transmitting wireless signals. Examples of such systems may be wireless local-area network (WLAN) Ultra High Reliability (UHR) systems (for example, IEEE 802.11bn or WI-FI® 8 systems), 5G or 6G wireless mobile communication systems, and the like.

### A. System Structure

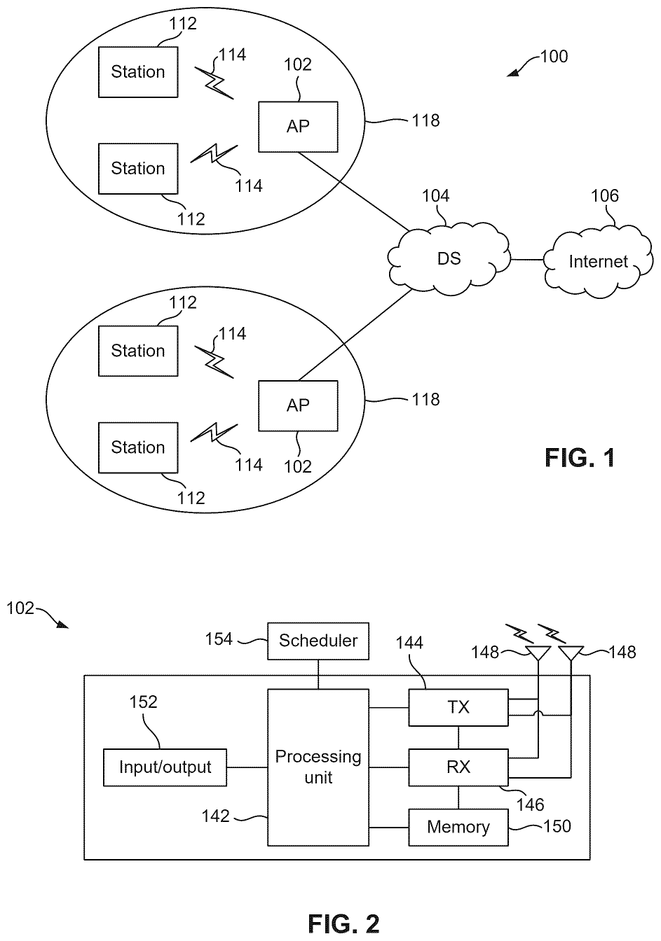

Turning now to FIG. 1, a communication system according to some embodiments of this disclosure is shown and is generally identified using reference numeral 100. As an example, the communication system 100 may be a WI-FI® system built under relevant standards such as IEEE 802.11 standard. As shown, the communication system 100 comprises a plurality of interconnected networking devices 102 such as a plurality of interconnected access points (APs; also called “base stations”) forming a distribution system (DS) 104 which is in turn connected to other networks such as the Internet 108 which may include a network of computers and subnets (intranets) or both, and incorporate protocols, such as Internet Protocol (IP), Transmission Control Protocol (TCP), User Datagram Protocol (UDP), and/or the like.

Each AP 102 is in wireless communication with one or more mobile or stationary stations 112 (STAs) through respective wireless channels 114 for providing wireless network connects thereto. Herein, the APs 102 and STAs 112 may be considered as different types of network nodes (or simply “nodes”) of the communication system 100. Each AP 102 and the STAs 112 connected thereto form a cell or basic service set (BSS) 118.

FIG. 2 is a simplified schematic diagram of an AP 102. As shown, the AP 102 comprises at least one processing unit 142 (also denoted at least one “processor”), at least one transmitter (TX) 144, at least one receiver (RX) 146 (collectively referred to as a transceiver), one or more antennas 148, at least one memory 150, and one or more input/output components or interfaces 152. A scheduler 154 may be coupled to the processing unit 142. The scheduler 154 may be included within or operated separately from the AP 102. Each of these components 142 to 154 may be implemented as one or more circuits (such as one or more electronic circuits and/or one or more optical circuits). Alternatively, the ensemble of these components 142 to 154 may be implemented as one or more circuits.

The processing unit 142 Is configured for performing various processing operations such as signal coding, data processing, power control, input/output processing, or any other suitable functionalities. The processing unit 142 may comprise a microprocessor, a microcontroller, a digital signal processor, a FPGA, an ASIC, and/or the like. In some embodiments, the processing unit 142 may execute computer-executable instructions or code stored in the memory 150 to perform various the procedures (otherwise referred to as methods) described below.

Each transmitter 144 may comprise any suitable structure for generating signals, such as control signals as described in detail below, for wireless transmission to one or more STAs 112. Each receiver 146 may comprise any suitable structure for processing signals received wirelessly from one or more STAs 112. Although shown as separate components, at least one transmitter 144 and at least one receiver 146 may be integrated and implemented as a transceiver. Each antenna 148 may comprise any suitable structure for transmitting and/or receiving wireless signals. Although common antennas 148 are shown in FIG. 2 as being coupled to both the transmitter 144 and the receiver 146, one or more antennas 148 may be coupled to the transmitter 144, and one or more other antennas 148 may be coupled to the receiver 146.

In some embodiments, an AP 102 may comprise a plurality of transmitters 144 and receivers 146 (or a plurality of transceivers) together with a plurality of antennas 148 for communication in its cell 118.

Each memory 150 may comprise any suitable volatile and/or non-volatile storage such as RAM, ROM, hard disk, optical disc, SIM card, solid-state memory, memory stick, SD memory card, and/or the like. The memory 150 may be used for storing instructions executable by the processing unit 142 and data used, generated, or collected by the processing unit 142. For example, the memory 150 may store instructions of software, software systems, or software modules that are executable by the processing unit 142 for implementing some or all of the functionalities and/or embodiments of the procedures performed by an AP 102 described herein.

Each input/output component 152 enables interaction with a user or other devices in the communication system 100. Each input/output device 152 may comprise any suitable structure for providing information to or receiving information from a user and may be, for example, a speaker, a microphone, a keypad, a keyboard, a display, a touch screen, a network communication interface, and/or the like.

Herein, the STAs 112 may be any suitable wireless device that may join the communication system 100 via an AP 102 for wireless operation. In various embodiments, a STA 112 may be a wireless electronic device used by a human or user (such as a smartphone, a cellphone, a personal digital assistant (PDA), a laptop, a desktop computer, a tablet, a smart watch, a consumer electronics device, and/or the like). A STA 112 may alternatively be a wireless sensor, an Internet-of-things (IoT) device, a robot, a shopping cart, a vehicle, a smart TV, a smart appliance, a wireless transmit/receive unit (WTRU), a mobile station, or the like. Depending on the implementation, the STA 112 may be movable autonomously or under the direct or remote control of a human, or may be positioned at a fixed position.

In some embodiments, a STA 112 may be a multimode wireless electronic device capable of operation according to multiple radio access technologies and incorporate multiple transceivers necessary to support such.

In addition, some or all of the STAs 112 comprise functionality for communicating with different wireless devices and/or wireless networks via different wireless links using different wireless technologies and/or protocols. Instead of wireless communication (or in addition thereto), the STAs 112 may communicate via wired communication channels to other devices or switches (not shown), and to the Internet 106. For example, a plurality of STAs 112 (such as STAs 112 in proximity with each other) may communicate with each other directly via suitable wired or wireless sidelinks.

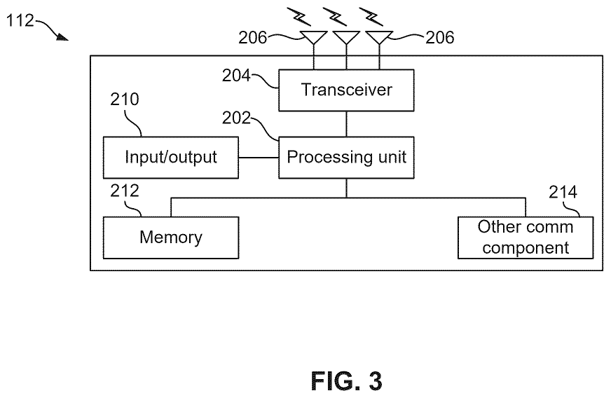

FIG. 3 is a simplified schematic diagram of a STA 112. As shown, the STA 112 comprises at least one processing unit 202, at least one transceiver 204, at least one antenna or network interface controller (NIC) 206, one or more input/output components 210, at least one memory 212, and at least one other communication component 214. Each of these components 202 to 214 may be implemented as one or more circuits (such as one or more electronic circuits and/or one or more optical circuits). Alternatively, the ensemble of these components 202 to 214 may be implemented as one or more circuits. In various embodiments, the STA 112 may also comprise other components as needed or as desired.

The processing unit 202 is configured for performing various processing operations such as signal coding, data processing, power control, input/output processing, or any other functionalities to enable the STA 112 to access and join the communication system 100 and operate therein. The processing unit 202 may also be configured to implement some or all of the functionalities of the STA 112 described in this disclosure. The processing unit 202 may comprise a central processing unit (CPU), a microprocessor, a microcontroller, a digital signal processor, an accelerator, a graphic processing unit (GPU), a tensor processing unit (TPU), a FPGA, or an ASIC. Examples of the processing unit 202 may be an ARM® microprocessor (ARM is a registered trademark of Arm Ltd., Cambridge, UK) manufactured by a variety of manufactures such as Qualcomm of San Diego, California, USA, under the ARM® architecture, an INTEL® microprocessor (INTEL is a registered trademark of Intel Corp., Santa Clara, CA, USA), an AMD® microprocessor (AMD is a registered trademark of Advanced Micro Devices Inc., Sunnyvale, CA, USA), and the like. In some embodiments, the processing unit 202 may execute computer-executable instructions or code stored in the memory 212 to perform various processes described below.

The at least one transceiver 204 may be configured for modulating data or other content for transmission by the at least one antenna 206 to communicate with an AP 102. The transceiver 204 is also configured for demodulating data or other content received by the at least one antenna 206. Each transceiver 204 may comprise any suitable structure for generating signals for wireless transmission and/or processing signals received wirelessly. Each antenna 206 may comprise any suitable structure for transmitting and/or receiving wireless signals. Although shown as a single functional unit, a transceiver 204 may be implemented separately as at least one transmitter and at least one receiver.

The one or more input/output components 210 is configured for interaction with a user or other devices in the communication system 100. Each input/output component 210 may comprise any suitable structure for providing information to or receiving information from a user and may be, for example, a speaker, a microphone, a keypad, a keyboard, a display, a touch screen, and/or the like.

The at least one memory 212 is configured for storing instructions executable by the processing unit 202 and data used, generated, or collected by the processing unit 202. For example, the memory 212 may store instructions of software, software systems, or software modules that are executable by the processing unit 202 for implementing some or all of the functionalities and/or embodiments of the STA 112 described herein. Each memory 212 may comprise any suitable volatile and/or non-volatile storage and retrieval components such as RAM, ROM, hard disk, optical disc, SIM card, solid-state memory modules, memory stick, SD memory card, and/or the like.

The at least one other communication component 214 is configured for communicating with other devices such as other STAs 112 via other communication means such as a radio link, a BLUETOOTH® link (BLUETOOTH is a registered trademark of Bluetooth Sig Inc., Kirkland, WA, USA), a wired sidelink, and/or the like. Examples of the wired sidelink may be a USB cable, a network cable, a parallel cable, a serial cable, and/or the like.

In some embodiments, a STA 112 may comprise a plurality of transceivers 204 and a plurality of antennas 206 for communication with an AP 102.

In the communication between the AP 102 and the STA 112, a transmission from the STA 112 to the AP 102 is usually denoted an uplink (UL) and the wireless channel used therefor is denoted an uplink channel. A transmission from the AP 102 to the STA 112 is usually denoted a downlink (DL) and the wireless channel used therefor is denoted a downlink channel.

In physical layer, the frequency-time resource of the channel 114 is partitioned into physical layer protocol data units (PPDUs; also called “packets”), and the AP 102 or STA 112 transmits data as PPDUs or packets. Suitable modulation technologies may be used for communication between the AP 102 and the STA 112. For example, in some embodiments, orthogonal frequency-division multiplexing (OFDM) may be used wherein the channel 114 is composed of a plurality orthogonal subcarriers for communication between the AP 102 and the STA 112. Moreover, as there are usually a plurality of STAs 112 in communication with a same AP 102, suitable multiple-access technologies may be used. For example, in some embodiments, orthogonal frequency-division multiple access (OFDMA) may be used for communication between the AP 102 and STAs 112.

### B. Long Training Fields (LTFs) for Distributive Resource Unit (DRU) Transmission

As those skilled in the art understand, a 802.11 physical frame comprises one or more LTFs each comprising a Long Training Sequence (LTS) for channel estimation, multi-input multi-output (MIMO) channel calibration, sounding, and/or the like. Depending on the length thereof, a LTF may be a 4×-LTF, a 2×-LTF, or a 1×-LTF. Herein, “4×-LTF” means the symbol length of the corresponding LTS is four (4) times of the symbol length of IEEE 802.11n/ac OFDM symbol (such as 12.8 microseconds (μsec or μs) excluding the Guard Interval (GI)), “2×-LTF” means the symbol length of the corresponding LTS is two (2) times of the symbol length of IEEE 802.11n/ac OFDM symbol (such as 6.4 μsec excluding the GI), and “1×-LTF means the symbol length of the corresponding LTS is the same as the symbol length of IEEE 802.11n/ac OFDM symbol (such as 3.2 μsec excluding the GI). The 2×-LTF feature was introduced in 802.11ax to reduce the LTF overhead by one half compared to 4×-LTF, while performance degradation was limited in certain channel environments.

The Long Training Sequence (LTS) of 2×-LTF occupies every other tone among the subcarriers that the 4×-LTF sequence occupies, and the tones which are not occupied by the 2×-LTF sequence are left blank with no energy, which creates the repeated samples in the time domain after taking an IDFT of 2×-LTF. Those repeated samples in the time domain are delineated into two repeating units in the middle of the OFDM symbol and only one repeating unit is transmitted, which reduces the LTF symbol length by one half. The following is the 2×-LTF sequence defined in 11ax in a 20 MHz transmission.

For subcarrier index range [−122:122], LTF used in highly efficient (HE) system, that is, the corresponding HE LTS (also called HE-LTF sequence) HELTF_{-122,122} (where the subscripts −122, 122 indicate the subcarrier index range [−122:122]) is: HELTF_{-122,122}={−1, 0, −1, 0, −1, 0, +1, 0, +1, 0, −1, 0, +1, 0, −1, 0, −1, 0, −1, 0, −1, 0, +1, 0, −1, 0, +1, 0, −1, 0, −1, 0, +1, 0, +1, 0, −1, 0, +1, 0, +1, 0, +1, 0, +1, 0, +1, 0, −1, 0, +1, 0, −1, 0, +1, 0, −1, 0, −1, 0, +1, 0, +1, 0, −1, 0, +1, 0, −1, 0, −1, 0, −1, 0, −1, 0, +1, 0, −1, 0, +1, 0, +1, 0, +1, 0, −1, 0, −1, 0, +1, 0, −1, 0, −1, 0, −1, 0, −1, 0, −1, 0, +1, 0, −1, 0, −1, 0, −1, 0, +1, 0, +1, 0, +1, 0, −1, 0, −1, 0, +1, 0, 0, 0, +1, 0, −1, 0, +1, 0, +1, 0, −1, 0, +1, 0, +1, 0, −1, 0, +1, 0, +1, 0, −1, 0, −1, 0, +1, 0, −1, 0, +1, 0, +1, 0, +1, 0, +1, 0, −1, 0, +1, 0, −1, 0, +1, 0, +1, 0, −1, 0, −1, 0, +1, 0, −1, 0, −1, 0, −1, 0, −1, 0, −1, 0, +1, 0, −1, 0, +1, 0, +1, 0, −1, 0, −1, 0, +1, 0, +1, 0, −1, 0, +1, 0, −1, 0, −1, 0, −1, 0, −1, 0, +1, 0, −1, 0, +1, 0, +1, 0, +1, 0, −1, 0, −1, 0, +1, 0, −1, 0, −1, 0, −1, 0, −1, 0, −1, 0, +1, 0, −1, 0, +1}.

As can be seen from the 2×-LTF sequence defined in IEEE 802.11ax, there is a zero between two non-zero sequences, which generates the repeated samples in the time domain after being taken with IDFT operation.

The DRU transmission takes the best advantage of TX Power boosting gain in an OFDMA-based TB PPDU in the 6 GHz Low Power Indoor (LPI) band where the DRU tones occupying the entire bandwidth can fully maximize the Power Spectral Density (PSD) requirements set each one (1) megahertz (MHz). However, the 2×-LTF sequence is not aligned with the DRU tone plan, that is, those tones the LTS of 2×-LTF occupy are not aligned with those tones the DRU tone plan occupy.

When DRUs are used, the 4×-LTF sequence occupies only the tones corresponding to the DRU tone plan in an OFDMA TB PPDU, just like the 4×-LTF sequence applies to the Regular Resource Unit (RRU) in the IEEE 11ax or 11be. However, unlike the RRUs, the tones of a DRU are distributed across the entire bandwidth, and any pair of tones in a DRU are spaced by at least one tone of other DRUs. In other words, any pair of tones in a DRU spaced by at least one blank or zero-energy tone.

Thus, the time-domain samples of 4×-LTF sequence corresponding to the several DRUs in 20, 40, or 80 MHz Bandwidth follow a repetition pattern. For example, when DRU is used, the first half time-domain samples a 4×-LTF sequence is a repeat of the second half time-domain samples the 4×-LTF sequence.

Accordingly, one may only transmit the first half samples of 4×-LTF corresponding to the DRU which has the repetition pattern in the time-domain samples, which can be the 2×-LTF transmission. That is, there may not be a need to define a separate 2×-LTF sequence. Rather, one may apply the 4×-LTF sequence to a DRU and generates the substantially repeated time-domain samples, and then simply transmit a half of time-domain samples as the 2×-LTF sequence.

Herein, the term “repeat” or “repeated” refers to the case that, when DRUs are used, a LTF sequence, after converted to the time domain using the IDFT operation, comprises a plurality of samples that may be partitioned into a plurality of sets of samples that follow a repetition pattern. In other words, one of the plurality of sets of samples may be the same as another one of the plurality of sets of samples, or may be obtained based on another one of the plurality of sets of samples by using one or more operations including negating (that is, switching the signs of the samples), complex conjugate, and/or the like.

The method disclosed herein may be targeted for a TB PPDU transmission in a 6 GHz LPI band, and may be used in WI-FI® 8 AP and/or STA devices, and/or other future WI-FI® AP and/or STA devices.

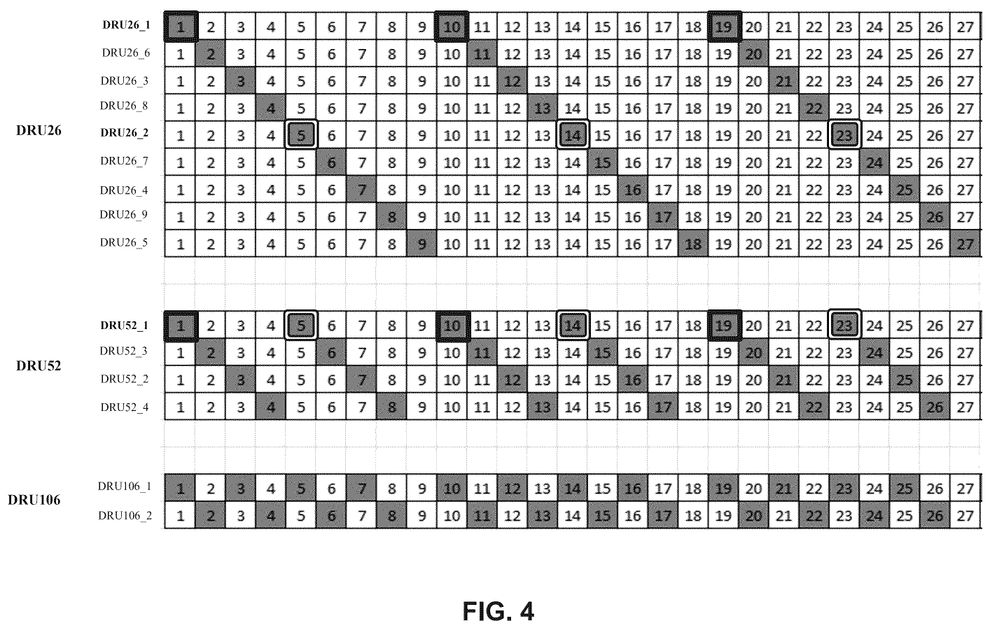

As explained above, the 2×-LTF sequence cannot be applied to the DRU tone plan, since the 2×-LTF sequence is not always aligned with the DRU tone. However, the repetition patterns are observed when the 4×-LTF sequence is assigned to a certain DRU tone plans. Hence, the DRU tone plan is important in determining the repetition in the time-domain samples. For example, the DRU tone plans according to “DRU Tone Plan for 11bn”, IEEE 802.11-24/468r2, by S. Hu, et. al. are shown in FIGS. 4 to 6 and are described as follows:

### Tone Plan for 20 MHz

According to “DRU Tone Plan for 11bn”, there are nine 26-tone DRUs, four 52-tone DRUs, and two 106-tone DRUs in the DRU Bandwidth (DBW) 20 MHz where the tone spacing is uniformly or quasi-uniformly distributed, that is, there is nine-tone spacing between the tones in 26-tone DRUs, four- or five-tone spacing between the tones in 52-tone DRUs, and two- or three-tone spacing between the tones in 106-tone DRUs; see FIG. 4.

### Tone Plan for 40 MHz

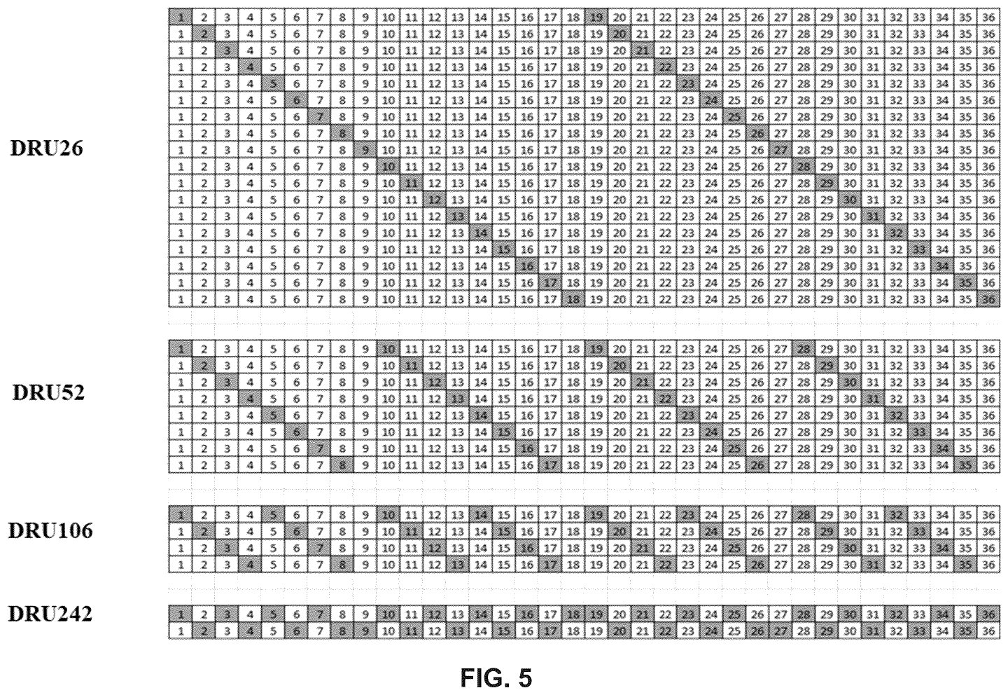

According to “DRU Tone Plan for 11bn”, there are eighteen 26-tone DRUs, eight 52-tone DRUs, four 106-tone DRUs and two 242-tone DRUs in the DRU Bandwidth (DBW) 40 MHz where the tone spacing is uniformly or quasi-uniformly distributed, that is, there is eighteen-tone spacing between the tones in 26-tone DRUs, nine-tone spacing between the tones in 52-tone DRUs, three- or four-tone spacing between the tones in 106-tone DRUs and 1˜3-tone spacing between the tones in 242-tone DRUs; see FIG. 5.

### Tone Plan for 80 MHz

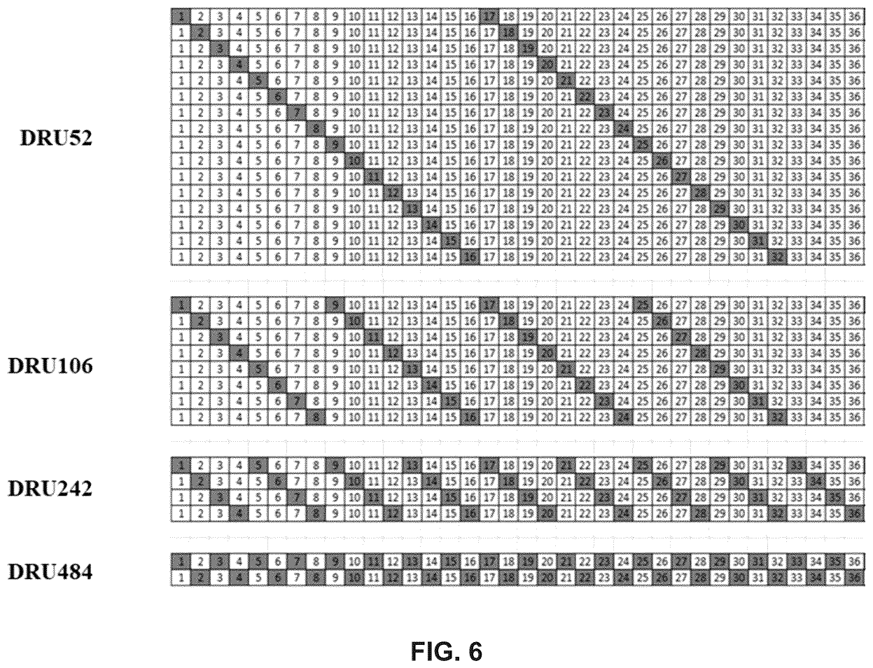

According to “DRU Tone Plan for 11bn”, there are sixteen 52-tone DRUs, eight 106-tone DRUs, four 242-tone DRUs and two 484-tone DRUs in the DRU Bandwidth (DBW) 80 MHz where the tone spacing is uniformly or quasi-uniformly distributed, that is, there is sixteen-tone spacing between the tones in 52-tone DRUs, eight-tone spacing between the tones in 106-tone DRUs, four-tone spacing between the tones in 242-tone DRUs and two-tone spacing between the tones in 484-tone DRUs; see FIG. 6.

As seen from FIGS. 4 to 6, some tones of DRUs are not aligned with the non-zero 2×-LTF sequence.

Hence, in some embodiments, the 4×-LTF sequences may be applied to the DRU tones even when transmission using 2×-LTF symbols is needed.

The IDFT operation of an LTF where the 4×-LTF sequences are only occupied at the same tones as the data DRU tones with the rest unoccupied creates the repeated samples. For example, the 1024-point IDFT operation of 4×-LTF sequence assigned on the tones overlapped with the any DRU106 or DRU242 data tones in 80 MHz as seen on FIG. 6 creates two substantially reverse repeated samples according to a certain 4×-LTF sequence, that is, the time-domain samples with the first sample through the 512th sample after the IDFT operation are repeated with the 513th sample through the 1024th sample after only negating the samples from the 513th sample to the 1024th sample.

For the 2×-LTF symbol transmission, those repeated samples in the time domain after the IDFT of the LTF symbol may be cut in half and transmit, which may reduce the LTF symbol size to one half. In other words, either the first half or the second half of the time-domain 4×-LTF samples may be transmitted as the 2×-LTF sequence. The rest of the time-domain 4×-LTF samples are not transmitted.

At the RX side, the received 2×-LTF symbol is appended with the same received 2×-LTF symbol or with the modified received 2×-LTF symbol (which may be negated or with additional arithmetic operation in case the repetition only takes place after the additional arithmetic operation such as a complex conjugate operation is applied to the appended samples), and then Discrete Fourier Transform (DFT) may be applied to the received samples before the channel estimation. If any smoothing is necessary to recover the entire channel parameters over the entire BW, it can be applied in the frequency domain after taking the DFT.

The repetition analysis for some DRU tone plans is as following.
52/106/242/484-tone DRU in 80 MHz have repetitions and the 2×-LTF-based TB PPDU may be applied.

In some of above embodiments, the 4×-LTF sequence is applied only to subcarriers corresponding to the non-zero DRU tones, even when transmitting the 2×-LTF based frame is needed, which gives rise to LTF overhead reduction.

In some of above embodiments, for the 2×-LTF symbol transmission, those repeated samples in the time domain after the IDFT of the LTF symbol are cut in half and transmit, which may reduce the LTF symbol size to one half. Accordingly, 2×-LTF transmission is made possible for the DRU-based TB PPDU.

In some of above embodiments, the 4×-LTF sequences are occupied at the same tones as the data DRU tones with the rest unoccupied in order to apply the 2×-LTF transmission, allowing application of the LTF sequences for the 2×-LTF-based TB PPDU transmission.

In principle, any OFDM symbol with a certain pattern of repetitions in the time domain can be truncated and transmitted, that is, in case an OFDM symbol creates 4 repetitions (that is, four repeated set of samples) in the time domain, it may only transmit one of two of the four repeated set of samples (such as the first repeated set of samples or the first half (which can correspond to the first and the second repeated samples) set of samples out of the 4 repeated set of samples in the time domain). The rest of the time-domain samples of the OFDM symbol are not transmitted.

Generally, a truncation ratio may be predefined or predetermined as the number of time-domain samples to be transmitted over the total number of time-domain samples of the OFDM symbol, such that at the TX side, the time-domain samples are selected based on the truncation ratio. Note that the truncation ratio may alternatively be predefined or predetermined as the number of time-domain samples not to be transmitted over the total number of time-domain samples of the OFDM symbol. Further alternatively, the truncation ratio may be predefined or predetermined as the number of time-domain samples to be transmitted over the number of time-domain samples not to be transmitted. All these definitions are equivalent and indicate the number of time-domain samples to be transmitted over the total number of time-domain samples of the OFDM symbol.

The truncation ratio is also predefined or predetermined at the RX side, or may be transmitted to the RX side. The RX side may need to append the received signal received over the truncated symbol length according to the truncation ratio in the TX side, for example, a quarter or a half symbol length of an OFDM symbol, that is, the truncation ratio determines how many times the RX may need to append the received signal received over the truncated symbol length. This truncation ratio can be indicated in a Common field or a special User Info field of a Trigger Frame.

### C. Acronyms, Abbreviations, and Definition of Some Terms

| | Acronym/Abbreviation/ |
|---|---|
| Full Name | Initialism |
| Distributive Resource Unit | DRU |
| Ultra-High Reliability | UHR |
| Trigger Based | TB |
| PHY Protocol Data Unit | PPDU |
| Long Training Field | LTF |
| Resource Unit | RU |
| Bandwidth | BW |
| High Efficiency | HE |
| Extreme High Throughput | EHT |
| Long Training Sequence | LTS |
| Inverse Discrete Fourier Transform | IDFT |
| Orthogonal Frequency Division Multiplex | OFDM |
| Mega Hertz | MHz |
| Giga Hertz | GHz |
| Low Power Indoor | LPI |
| Orthogonal Frequency Division Multiplex | OFDMA |
| Access | |
| Power Spectral Density | PSD |
| DRU Bandwidth | DBW |

Herein, the term “predefined” (for example, a “predefined” item such as a “predefined” parameter) refers to an item defined before the method disclosed herein is performed (for example, defined as a system design parameter such as defined by relevant standards).

Herein, the term “preconfigured” (for example, a “preconfigured” item such as a “preconfigured” parameter) refers to an item configured by a suitable apparatus before a certain even occurs.

Herein, use of language such as “at least one of X, Y, and Z,” “at least one of X, Y, or Z,” “at least one or more of X, Y, and Z,” “at least one or more of X, Y, and/or Z,” or “at least one of X, Y, and/or Z,” is intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

Herein, various embodiments are described. In various embodiments, the methods disclosed herein may be implemented as hardware, software, firmware, or a combination thereof, and may be implemented in any suitable form. Depending on the functionalities of various features of the methods disclosed herein, some features may be implemented on the network side (such as in one or more APs), some other features may be implemented on the STA side, and/or yet some other features may be implemented on both the AP and the STA sides. Depending on the functionalities of various features of the methods disclosed herein, some features may be implemented on the transmitting side (such as in one or more APs and/or one or more STAs for transmission), some other features may be implemented on the receiving side (such as in one or more APs and/or one or more STAs for receiving), and/or yet some other features may be implemented on both the transmitting and the receiving sides.

For example, in some embodiments, the methods disclosed herein may be implemented as computer-executable instructions stored in one or more non-transitory computer-readable storage devices (in the form of software, firmware, or a combination thereof) such that, the instructions, when executed, may cause one or more physical components such as one or more circuits to perform the methods disclosed herein.

For example, in some embodiments, an apparatus comprising one or more processors functionally connected to one or more non-transitory computer-readable storage devices or media may be used to perform the methods disclosed herein, wherein the one or more non-transitory computer-readable storage devices or media store the computer-executable instructions of the methods disclosed herein, and the one or more processors may read the computer-executable instructions from the one or more non-transitory computer-readable storage devices or media, and executes the instructions to perform the methods disclosed herein.

In some embodiments, an apparatus may not have any processors or computer-readable storage devices or media. Rather, the apparatus may comprise any other suitable physical or virtual (explained below) components for implementing the methods disclosed herein.

In some embodiments, the computer-executable instructions that implement the methods disclosed herein may be one or more computer programs, one or more program products, or a combination thereof.

In some embodiments, the methods disclosed herein may be implemented as one or more circuits, one or more components, one or more units, one or more modules, one or more integrated-circuit (IC) chips, one or more chipsets, one or more devices, one or more apparatuses, one or more systems, and/or the like.

The one or more circuits, one or more components, one or more units, one or more modules, one or more IC chips, one or more chipsets, one or more devices, one or more apparatuses, or one or more systems may be physical, virtual, or a combination thereof. Herein, the term “virtual” (such as a “virtual apparatus”) refers to a circuit, component, unit, module, chipset, device, apparatus, system, or the like that is simulated or emulated or otherwise formed using suitable software or firmware such that it appears as if it is “real” or physical).

The present disclosure encompasses various embodiments, including not only method embodiments, but also other embodiments such as apparatus embodiments and embodiments related to non-transitory computer readable storage media. Embodiments may incorporate, individually or in combinations, the features disclosed herein.

Although this disclosure refers to illustrative embodiments, this is not intended to be construed in a limiting sense. Various modifications and combinations of the illustrative embodiments, as well as other embodiments of the disclosure, will be apparent to persons skilled in the art upon reference to the description.

Features disclosed herein in the context of any particular embodiments may also or instead be implemented in other embodiments. Method embodiments, for example, may also or instead be implemented in apparatus, system, and/or computer program product embodiments. In addition, although embodiments are described primarily in the context of methods and apparatus, other implementations are also contemplated, as instructions stored on one or more non-transitory computer-readable media, for example. Such media could store programming or instructions to perform any of various methods consistent with the present disclosure.

Those skilled in the art will appreciate that the various embodiments and/or features disclosed herein may be customized and/or combined as needed or desired. Moreover, although embodiments have been described above with reference to the accompanying drawings, those of skill in the art will appreciate that variations and modifications may be made without departing from the scope thereof as defined by the appended claims.

What is claimed is:

1. A communication method comprising:
generating time-domain samples of an orthogonal frequency-division multiplexing (OFDM) symbol, the time-domain samples comprising a plurality of sets of samples, each of the plurality of sets of samples being the same as another one of the plurality of sets of samples or being obtainable based on the another one of the plurality of sets of samples by using one or more operations including negating, complex conjugate, or a combination thereof; and
transmitting a packet comprising a portion of the time-domain samples of the OFDM symbol, the portion of the time-domain samples comprising one or more selected sets of samples selected from the plurality of sets of samples in accordance with a ratio indicating a number of the portion of the time-domain samples over a total number of the time-domain samples of the OFDM symbol.

2. The communication method of claim 1 further comprising:
transmitting a trigger frame indicating the ratio in a common field or a user info field of the trigger frame.

3. The communication method of claim 1, wherein the portion of the time-domain samples of the OFDM symbol comprises first half of the time-domain samples of the OFDM symbol; or
wherein the time-domain samples of the OFDM symbol comprise four sets of samples, and the portion of the time-domain samples of the OFDM symbol comprises one of the four sets of samples.

4. The communication method of claim 1, wherein the OFDM symbol comprises a first long training field (LTF) sequence applied to a set of distributive resource units (DRU) tones, and the portion of the time-domain samples of the OFDM symbol correspond to a second LTF sequence.

5. The communication method of claim 4, wherein the first LTF sequence is a 4×-LTF sequence, and the second LTF sequence is a 2×-LTF sequence.

6. One or more processors functionally coupled to one or more non-transitory computer-readable storage media, wherein the one or more non-transitory computer-readable storage media comprise computer-executable instructions; and wherein the instructions, when executed, cause the one or more processors to perform the method of claim 1.

7. The one or more processors of claim 6, wherein the instructions, when executed, cause the one or more processors to perform further actions comprising:
transmitting a trigger frame indicating the ratio in a common field or a user info field of the trigger frame.

8. The one or more processors of claim 6, wherein the OFDM symbol comprises a first long training field (LTF) sequence applied to a set of distributive resource units (DRU) tones, and the portion of the time-domain samples of the OFDM symbol correspond to a second LTF sequence.

9. One or more non-transitory computer-readable storage media comprising computer-executable instructions, wherein the instructions, when executed, cause one or more processors to perform the method of claim 1.

10. The one or more non-transitory computer-readable storage media of claim 9, wherein the instructions, when executed, cause the one or more processors to perform further actions comprising:
transmitting a trigger frame indicating the ratio in a common field or a user info field of the trigger frame.

11. The one or more non-transitory computer-readable storage media of claim 9, wherein the OFDM symbol comprises a first long training field (LTF) sequence applied to a set of distributive resource units (DRU) tones, and the portion of the time-domain samples of the OFDM symbol correspond to a second LTF sequence.

12. A communication method comprising:
receiving a packet comprising a portion of time-domain samples of an orthogonal frequency-division multiplexing (OFDM) symbol; and
obtaining all time-domain samples of the OFDM symbol based on the portion of time-domain samples for channel estimation or data reception.

13. The communication method of claim 12, wherein said obtaining all time-domain samples of the OFDM symbol comprises:
in accordance with a ratio indicating a number of the portion of the time-domain samples over a total number of the time-domain samples of the OFDM symbol, obtaining one or more sets of time-domain samples based on the portion of time-domain samples, each of the one or more sets of time-domain samples being the same as the portion of time-domain samples or being obtained based on the portion of time-domain samples by using one or more operations including negating, complex conjugate, or a combination thereof; and
combining the portion of time-domain samples and the one or more sets of time-domain samples to obtain all time-domain samples of the OFDM symbol.

14. The communication method of claim 13 further comprising:
receiving a trigger frame; and
obtaining the ratio from a common field or a user info field of the trigger frame.

15. The communication method of claim 12, wherein the OFDM symbol comprises a first long training field (LTF) sequence applied to a set of distributive resource units (DRU) tones, and the portion of the time-domain samples of the OFDM symbol correspond to a second LTF sequence.

16. The communication method of claim 15, wherein the first LTF sequence is a 4×-LTF sequence, and the second LTF sequence is a 2×-LTF sequence.

17. One or more processors functionally coupled to one or more non-transitory computer-readable storage media, wherein the one or more non-transitory computer-readable storage media comprise computer-executable instructions; and wherein the instructions, when executed, cause the one or more processors to perform the method of claim 12.

18. The one or more processors of claim 17, wherein said obtaining all time-domain samples of the OFDM symbol comprises:
in accordance with a ratio, obtaining one or more sets of time-domain samples based on the portion of time-domain samples, each of the one or more sets of time-domain samples being the same as the portion of time-domain samples or being obtained based on the portion of time-domain samples by using one or more operations including negating, complex conjugate, or a combination thereof; and
combining the portion of time-domain samples and the one or more sets of time-domain samples to obtain all time-domain samples of the OFDM symbol.

19. One or more non-transitory computer-readable storage media comprising computer-executable instructions, wherein the instructions, when executed, cause one or more processors to perform the method of claim 12.

20. The one or more non-transitory computer-readable storage media of claim 19, wherein said obtaining all time-domain samples of the OFDM symbol comprises:
in accordance with a ratio, obtaining one or more sets of time-domain samples based on the portion of time-domain samples, each of the one or more sets of time-domain samples being the same as the portion of time-domain samples or being obtained based on the portion of time-domain samples by using one or more operations including negating, complex conjugate, or a combination thereof; and
combining the portion of time-domain samples and the one or more sets of time-domain samples to obtain all time-domain samples of the OFDM symbol.
